(19) United States
(12) Patent Application Publication
(10) Pub. No.: US 2026/0133785 A1
(43) Pub. Date: May 14, 2026

(54) FIRMWARE UPDATE METHOD AND SYSTEM WITH FLEXIBLE TIME LIMIT

(71) Applicant: American Megatrends International, LLC, Duluth, GA (US)

(72) Inventors: Hung-Ping HSU, Duluth, GA (US); Wei-Cen CHEN, Duluth, GA (US); Chih-Yin CHANG, Duluth, GA (US)

(73) Assignee: American Megatrends International, LLC, Duluth, GA (US)

(21) Appl. No.: 18/946,144

(22) Filed: Nov. 13, 2024

(51) Int. Cl. G06F 8/65

(52) U.S. Cl. CPC G06F 8/65

(57) ABSTRACT

A firmware update method through a bus interface and a system performing the same are provided. The method comprises: sending, by an update initiator to an update object to which a firmware image is to be transferred, an update command to start an update session; obtaining, by the update initiator from the bus interface, a data rate toward the update object; calculating a transfer time estimate by dividing an image size of the firmware image with the data rate; setting a transfer time limit to a default value; determining whether the transfer time estimate is longer than the transfer time limit; and in response to determining that the transfer time estimate is longer than the transfer time limit, setting the transfer time limit to the transfer time estimate.

### FIELD OF INVENTION

The present invention relates to device firmware update, and more particularly to a firmware update method with flexible time limit and a system performing the same.

### BACKGROUND

To implement platform management for server-class computer systems, baseboard management controllers (BMCs) have become indispensable. A BMC is a specialized microcontroller embedded on the motherboard of a computer, which manages the interface between the system management software and the platform hardware. In line with significant and rapid advances in server management, the BMC introduces various hardware and software services that require numerous and frequent firmware revisions and updates.

In conventional systems, a BMC communicates through a bus interface to devices with firmware to be updated. Each device may couple the bus interface via either a fast path (PCIe for example) or a slow path (I2C for example) under cost-performance tradeoffs. On the other hand, firmware images are often subject to size gains along their developments. Without considering data rate toward the device and size of the firmware image, there is a risk that the BMC might determine a timeout event while transfer of the firmware image is still in progress, resulting in a wrongful cancellation of the update session.

### SUMMARY

One objective of the present invention is to provide a firmware update method and a system performing the same, characterized in a capability of setting a flexible time limit so that timeout events are correctly determined.

Another objective of the present invention is to provide a firmware update method and a system performing the same, characterized in a capability of setting a flexible time limit without changing the criteria in the source code for different image sizes.

In a first embodiment of the present invention, a firmware update method through a bus interface comprises: sending, to an update object to which a firmware image is to be transferred, an update command to start an update session; obtaining, from the bus interface, a data rate toward the update object; calculating a transfer time estimate by dividing an image size of the firmware image with the data rate; setting a transfer time limit to a default value; determining whether the transfer time estimate is longer than the transfer time limit; and in response to determining that the transfer time estimate is longer than the transfer time limit, setting the transfer time limit to the transfer time estimate.

In one aspect of the first embodiment, the firmware update method further comprises: sending, to the update object, a transfer command to request transferring the firmware image; upon receiving, from the update object, a response accepting the firmware image, starting to count a time duration until the transfer time limit is reached; and if a transfer result has not been received from the update object, sending, to the update object, a cancel command to cancel the update session.

In one aspect of the first embodiment, the data rate is obtained from a look-up table contained within the bus interface.

In one aspect of the first embodiment, calculating the transfer time estimate further comprise adding an encryption overhead to the transfer time estimate.

In one aspect of the first embodiment, the default value equals 600 seconds.

In one aspect of the first embodiment, the update initiator is implemented by a baseboard management controller (BMC).

In one aspect of the first embodiment, the update object is an input/output (I/O) device.

In one aspect of the first embodiment, the update object forwards the firmware image to one or more other update objects.

In a second embodiment of the present invention, a system performing firmware update through a bus interface comprises an update object and an update initiator. A firmware image is to be transferred to the update object. The update initiator is configured to: send, to the update object, an update command to start an update session; obtain, from the bus interface, a data rate toward the update object; calculate a transfer time estimate by dividing an image size of the firmware image with the data rate; set a transfer time limit to a default value; determine whether the transfer time estimate is longer than the transfer time limit; and in response to determining that the transfer time estimate is longer than the transfer time limit, set the transfer time limit to the transfer time estimate.

In one aspect of the second embodiment, the update initiator is further configured to: send, to the update object, a transfer command to request transferring the firmware image; upon receiving, from the update object, a response accepting the firmware image, start to count a time duration until the transfer time limit is reached; and if a transfer result has not been received from the update object, send, to the update object, a cancel command to cancel the update session.

In one aspect of the second embodiment, the data rate is obtained from a look-up table contained within the bus interface.

In one aspect of the second embodiment, the update initiator is further configured to add an encryption overhead to the transfer time estimate.

In one aspect of the second embodiment, the default value equals 600 seconds.

In one aspect of the second embodiment, the update initiator is implemented by a baseboard management controller (BMC).

In one aspect of the second embodiment, the update object is an input/output (I/O) device.

In one aspect of the second embodiment, the update object forwards the firmware image to one or more other update objects.

### BRIEF DESCRIPTION OF THE DRAWINGS

FIG. 1 is a logical block diagram of a system performing firmware update according to an embodiment of the present invention.

FIG. 2 is a physical block diagram of a system performing firmware update according to an embodiment of the present invention.

FIG. 3 is a flow chart of a primary portion of a firmware update method according to an embodiment of the present invention.

FIG. 4 is a flow chart of a secondary portion of a firmware update method according to an embodiment of the present invention.

### DETAILED DESCRIPTION

Embodiments of the present invention are set forth below in connection with the appended drawings, for the purpose of providing a thorough understanding of various concepts while not intended to represent the only configurations in which the concepts described herein may be practiced. It will be apparent to those skilled in the art that these concepts may be practiced without these specific details. Well known structures and components are omitted in order to avoid obscuring such concepts.

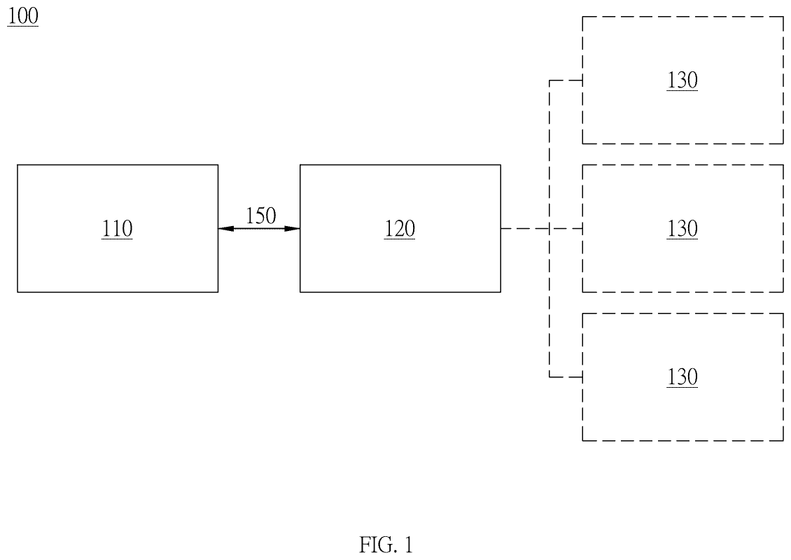

In a logical sense as shown in FIG. 1, a system 100 performing firmware update through a bus interface 150 includes an update initiator 110 and an update object 120. The update initiator 110 begins by sending an update command to the update object 120. If the update object 120 is in an idle state, it replies with a response indicating availability for firmware update, and an update session is started until various update steps (component information table delivery, firmware image transfer, verification and activation, etc.) have been completed. In case of any error or timeout event, the update initiator 110 may also send a cancel command to cancel the update session, so that the update object 120 can return to the idle state. As also shown in FIG. 1, the update object 120 may alternatively forward the firmware image to one or more other update objects 130, and process firmware update commands/responses/events on behalf of the other update objects 130.

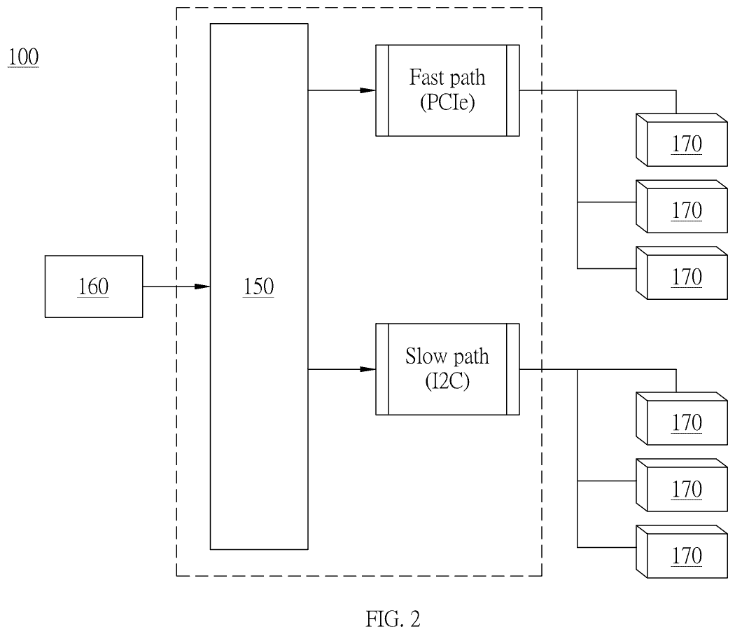

Now refer to FIG. 2 showing a physical system performing firmware update. The update initiator is typically implemented by a BMC 160, which communicates through the bus interface 150 to firmware devices 170 acting as update objects. Each firmware device 170 (e.g., input/output (I/O) device) contains one or more elements (controller, processor, etc.) which execute firmware, and may couple the bus interface 150 via either a fast path (PCIe for example) or a slow path (I2C for example).

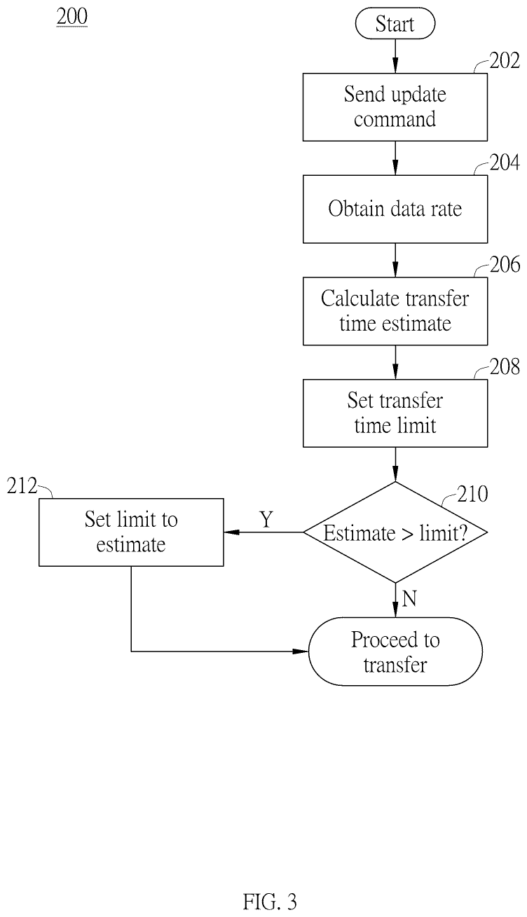

FIG. 3 is a flow chart of a primary portion of a firmware update method 200 according to an embodiment of the present invention. The method 200 starts at step 202, where the update initiator 110 (which may be a BMC or any other equivalent entity) sends, to an update object 120 (which may be a firmware device or any other equivalent entity) to which a firmware image is to be transferred, an update command to start an update session. At step 204, the update initiator 110 obtains, from the bus interface 150, a data rate toward the update object 120. The data rate may be obtained from a look-up table contained within the bus interface 150, but the present invention is not limited hereto. At step 206, the update initiator 110 calculates a transfer time estimate by dividing an image size of the firmware image with the data rate. In an aspect, the update initiator 110 may further add an encryption overhead to the transfer time estimate, so that access to cryptographic capabilities and operations is enabled. At step 208, the update initiator 110 sets a transfer time limit to a default value. The default value may equal 600 seconds, but the present invention is not limited hereto. The transfer time estimate and the transfer time limit are compared at decision 210. If the transfer time estimate is determined to be longer than the transfer time limit, the transfer time limit is set to the transfer time estimate at step 212, before proceeding to firmware image transfer as conclusion of the primary portion of the firmware update method 200.

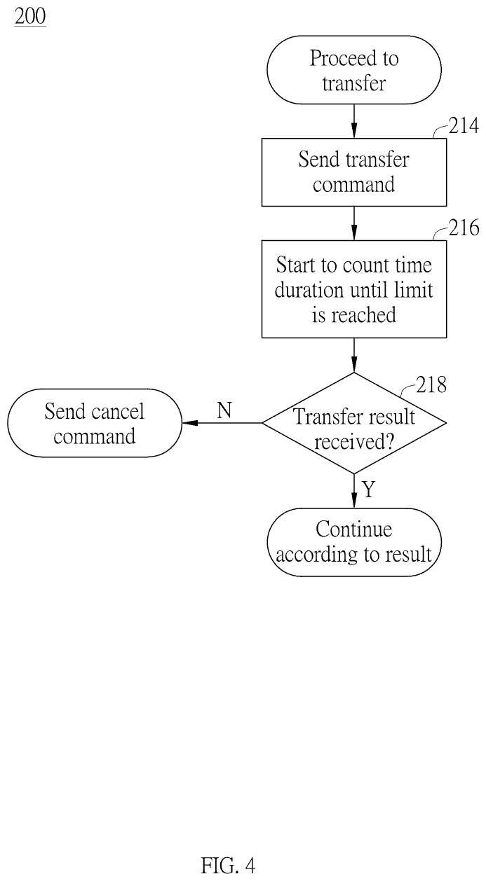

FIG. 4 is a flow chart of a secondary portion of a firmware update method 200 according to an embodiment of the present invention. At step 214, the update initiator 110 sends, to the update object 120, a transfer command to request transferring the firmware image. Upon receiving, from the update object 120, a response accepting the firmware image, the update initiator 110 starts to count a time duration at step 216 until the transfer time limit is reached. If a transfer result has not been received from the update object 120 at decision 218, the update initiator 110 sends, to the update object 120, a cancel command to cancel the update session; otherwise, the update initiator 110 continues the update session according to the transfer result. In an aspect, if the transfer result indicates any error, the update initiator 110 may resend a transfer command to the update object 120; if the transfer result indicates no error, firmware image transfer is completed and the update initiator 110 may take no action unless requested by the update object 120.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The foregoing description is provided to enable any person skilled in the art to practice the various aspects described herein, and is not intended to be exhaustive or to limit the present invention to the precise forms disclosed. Various modifications to these aspects will be readily apparent to those skilled in the art, and the generic principles defined herein may be applied to other aspects. Accordingly, the scope of the present invention is to be accorded the broadest scope consistent with the appended claims rather than the foregoing description and the exemplary embodiments described therein.

What is claimed is:

1. A firmware update method through a bus interface, comprising:
sending, to an update object to which a firmware image is to be transferred, an update command to start an update session;
obtaining, from the bus interface, a data rate toward the update object;
calculating a transfer time estimate by dividing an image size of the firmware image with the data rate;
setting a transfer time limit to a default value;
determining whether the transfer time estimate is longer than the transfer time limit; and
in response to determining that the transfer time estimate is longer than the transfer time limit, setting the transfer time limit to the transfer time estimate.

2. The firmware update method of claim 1, further comprising:
sending, to the update object, a transfer command to request transferring the firmware image;
upon receiving, from the update object, a response accepting the firmware image, starting to count a time duration until the transfer time limit is reached; and
if a transfer result has not been received from the update object, sending, to the update object, a cancel command to cancel the update session.

3. The firmware update method of claim 1, wherein the data rate is obtained from a look-up table contained within the bus interface.

4. The firmware update method of claim 1, wherein calculating the transfer time estimate further comprise adding an encryption overhead to the transfer time estimate.

5. The firmware update method of claim 1, wherein the default value equals 600 seconds.

6. The firmware update method of claim 1, wherein the update initiator is implemented by a baseboard management controller (BMC).

7. The firmware update method of claim 1, wherein the update object is an input/output (I/O) device.

8. The firmware update method of claim 1, wherein the update object forwards the firmware image to one or more other update objects.

9. A system performing firmware update through a bus interface, comprising:
an update object to which a firmware image is to be transferred; and
an update initiator configured to:
send, to the update object, an update command to start an update session;
obtain, from the bus interface, a data rate toward the update object;
calculate a transfer time estimate by dividing an image size of the firmware image with the data rate;
set a transfer time limit to a default value;
determine whether the transfer time estimate is longer than the transfer time limit; and
in response to determining that the transfer time estimate is longer than the transfer time limit, set the transfer time limit to the transfer time estimate.

10. The system performing firmware update of claim 9, wherein the update initiator is further configured to:
send, to the update object, a transfer command to request transferring the firmware image;
upon receiving, from the update object, a response accepting the firmware image, start to count a time duration until the transfer time limit is reached; and
if a transfer result has not been received from the update object, send, to the update object, a cancel command to cancel the update session.

11. The system performing firmware update of claim 9, wherein the data rate is obtained from a look-up table contained within the bus interface.

12. The system performing firmware update of claim 9, wherein the update initiator is further configured to add an encryption overhead to the transfer time estimate.

13. The system performing firmware update of claim 9, wherein the default value equals 600 seconds.

14. The system performing firmware update of claim 9, wherein the update initiator is implemented by a baseboard management controller (BMC).

15. The system performing firmware update of claim 9, wherein the update object is an input/output (I/O) device.

16. The system performing firmware update of claim 9, wherein the update object forwards the firmware image to one or more other update objects.
